(19) United States
(12) Patent Application Publication
(10) Pub. No.: US 2018/0072950 A1
(43) Pub. Date: Mar. 15, 2018

(54) LIQUID CRYSTAL COMPOSITION AND LIQUID CRYSTAL DISPLAY INCLUDING THE SAME

(71) Applicant: Samsung Display Co., Ltd., Yongin-si (KR)

(72) Inventors: Tae Ho KIM, Yongin-si (KR); Min-Hee KIM, Ansan-si (KR); Kyung Ho PARK, Hwaseong-si (KR); So Youn PARK, Hwaseong-si (KR); Mi Hwa LEE, Seoul (KR); Chang-Hun LEE, Hwaseong-si (KR)

(21) Appl. No.: 15/497,151

(22) Filed: Apr. 25, 2017

(30) Foreign Application Priority Data
Sep. 9, 2016 (KR) 10-2016-0116412

(51) Int. Cl. C09K 19/30; C09K 19/34; C09K 19/56; G02F 1/1337

(52) U.S. Cl. CPC C09K 19/3066; C09K 19/30; C09K 19/3402; C09K 2019/122; G02F 1/1337; G02F 1/133711; C09K 19/56

(57) ABSTRACT

A liquid crystal composition and a display device having the liquid crystal composition. The liquid crystal composition including at least one compound selected from the group consisting of Chemical Formula 1, Chemical Formula 2, Chemical Formula 3, and Chemical Formula 4. Chemical Formulas 1, 2, 3, and 4 are as follows:

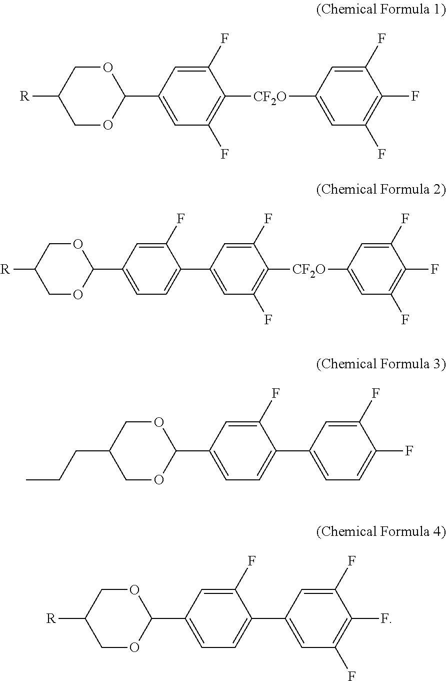

R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

### CROSS-REFERENCE TO RELATED APPLICATION

This application claims priority from and the benefit of Korean Patent Application No. 10-2016-0116412, filed Sep. 9, 2016, which is hereby incorporated by reference for all purposes as if fully set forth herein.

### BACKGROUND

### Field

Exemplary embodiments relate to a liquid crystal composition and a liquid crystal display including the same.

### Discussion of the Background

A liquid crystal display (LCD) includes at least one display panel including an electric field generation electrode, such as a pixel electrode and a common electrode, and a liquid crystal layer where an electric field generated by the electric field generation electrode is formed. The liquid crystal display device determines alignment of liquid crystal molecules in the liquid crystal layer and controls transmittance of light passing through the liquid crystal layer by applying a voltage to the electric field generation electrode to generate an electric field in the liquid crystal layer.

In a liquid crystal display, a liquid crystal composition is very important for controlling light transmittance to obtain a desired image. Particularly, according to various usages of the liquid crystal display, various characteristics such as low driving voltage, a high voltage holding ratio (VHR), a wide viewing angle characteristic, a wide operation temperature range, and high speed response are required. However, problems, including display defects and low contrast ratio (CR), occur with existing liquid crystal composition having positive dielectric anisotropy.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal composition that has positive dielectric anisotropy with an improved contrast ratio (CR) while reducing a flicker phenomenon occurring at a low driving frequency, and a liquid crystal display including the same.

Additional aspects will be set forth in the detailed description which follows, and, in part, will be apparent from the disclosure, or may be learned by practice of the inventive concepts.

According to exemplary embodiments, a liquid crystal composition includes at least one compound selected from the group consisting of Chemical Formula 1, Chemical Formula 2, Chemical Formula 3, and Chemical Formula 4. Chemical Formulas 1, 2, 3, and 4 are as follows:

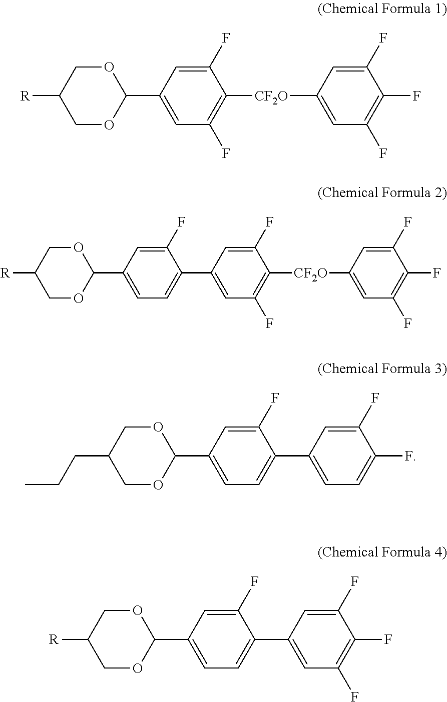

R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

According to an exemplary embodiment, a liquid crystal display (LCD) includes a first substrate, a first electrode and a second electrode disposed on the first substrate and insulated from each other, a second substrate overlapping the first substrate; and a liquid crystal layer disposed between the first substrate and the second substrate. The liquid crystal layer includes a liquid crystal composition including at least one compound selected from the group consisting of Chemical Formula 1, Chemical Formula 2, Chemical Formula 3, and Chemical Formula 4. Chemical Formulas 1, 2, 3, and 4 are as follows:

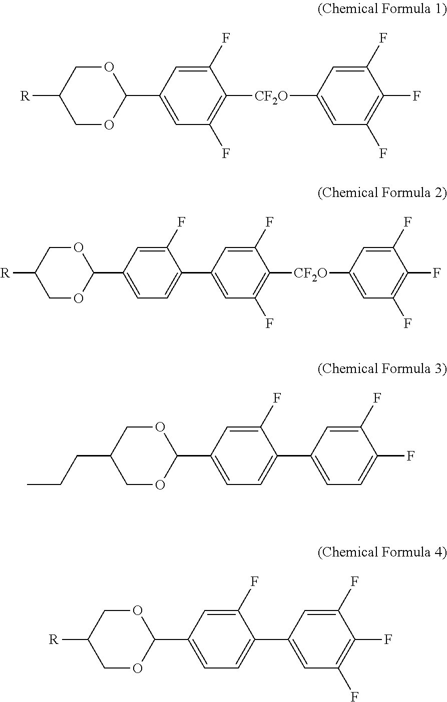

R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

The liquid crystal composition having positive dielectric anisotropy according to the above-described exemplary embodiment can reduce the flicker phenomenon and improve the contrast ratio.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 schematically shows a liquid crystal director.

FIG. 2 is a top plan view of a liquid crystal display according to an exemplary embodiment.

FIG. 3 is a cross-sectional view of FIG. 2, taken along the line III-III′.

FIG. 4 is a schematic cross-sectional view of alignment of liquid crystal molecules according to whether an electric field is applied or not in the liquid crystal display according to an exemplary embodiment.

FIG. 5 is a graph illustrating zeta flicker values according to an exemplary embodiment and comparative examples.

FIG. 6 is a graph illustrating flicker values at 30 Hz according to an exemplary embodiment and comparative examples.

FIG. 7 is a graph illustrating a voltage holding ratio VHR according to an exemplary embodiment and comparative examples.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure any Markush group phrase may be construed as inclusive of all combinations of one or more of the associated listed items. For example, “at least one of X, Y, and Z,” “at least one compound of X, Y, and Z” “at least one compound selected from the group consisting of X, y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

A liquid crystal composition according to an exemplary embodiment will now be described. The liquid crystal composition according to the exemplary embodiment includes at least one compound selected from the group consisting of Chemical Formulas 1, 2, 3, and 4.

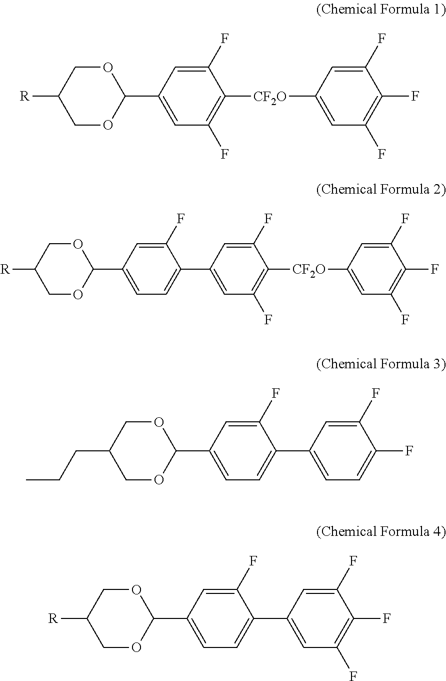

Here, R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

The compounds represented as given in Chemical Formulas 1 to 4 include dioxane. The liquid crystal composition that includes dioxane can improve vertical direction permittivity and reduce deformation of the alignment of the liquid crystal molecules to the same voltage. Accordingly, a flexoelectric level according to the deformation of the liquid crystal molecule alignment can be reduced and a flicker phenomenon can be reduced.

The total amount of compounds represented by Chemical Formulas 1 to 3 may be about 20 wt % or more with respect to the amount of the liquid crystal composition, and specifically, the amount of each of the compounds respectively represented by Chemical Formulas 1 to 3 may be about 5 wt % or more with respect to the amount of the liquid crystal composition. In addition, the amount of the compound represented by Chemical Formula 4 may be about 1 wt % or more with respect to the amount of the liquid crystal composition.

The liquid crystal composition according to the exemplary embodiment may further include compounds that are respectively represented by Chemical Formulas 5, 6, 7, 8, 9, 10, 11, and 12.

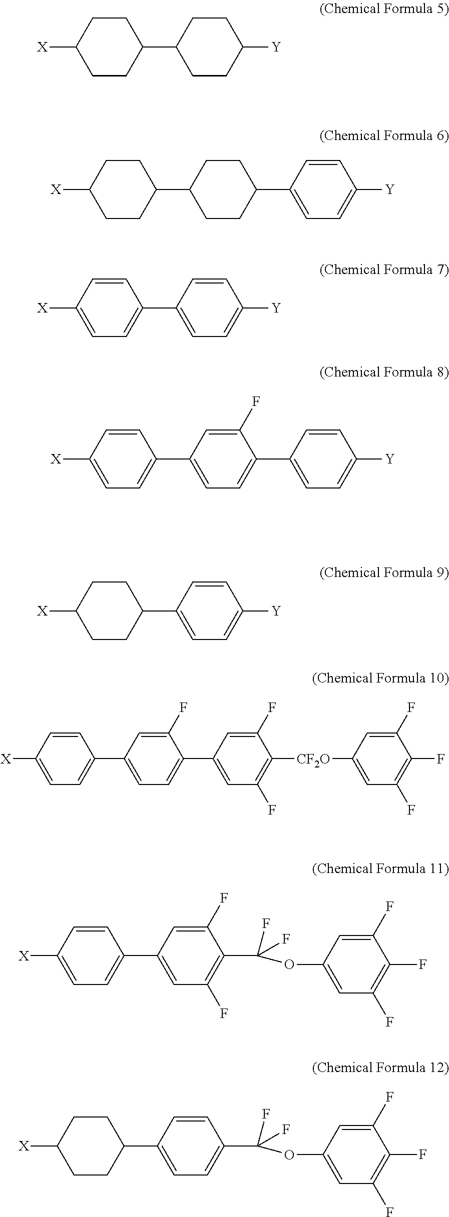

X and Y are independently an alkyl group having 1 to 7 carbon atoms, an alkenyl group having 2 to 7 carbon atoms, or an alkoxy group having 1 to 7 carbon atoms.

The amount of the compound represented by Chemical Formula 5 may be about 30 wt % to 50 wt % with respect to the entire liquid crystal composition, the amount of the compound represented by Chemical Formula 6 may be about 5 wt % to 25 wt % with respect to the entire liquid crystal composition, the amount of the compound represented by Chemical Formula 7 may be about 1 wt % to 10 wt % with respect to the entire liquid crystal composition, the amount of the compound represented by Chemical Formula 8 may be about 1 wt % to 15 wt % with respect to the entire liquid crystal composition, the amount of the compound represented by Chemical Formula 9 may be about 5 wt % to 10 wt % with respect to the entire liquid crystal composition, the amount of the compound represented by Chemical Formula 10 may be about 1 wt % to 20 wt % with respect to the entire liquid crystal composition, the amount of the compound represented by Chemical Formula 11 may be about 5 wt % or less with respect to the entire liquid crystal composition, and the amount of the compound represented by Chemical Formula 12 may be about 5 wt % to 15 wt % with respect to the entire liquid crystal composition.

The above-stated liquid crystal composition may have positive dielectric anisotropy. A liquid crystal composition having positive dielectric anisotropy has a problem that the flicker phenomenon is easier to see than with a liquid crystal composition having negative dielectric anisotropy.

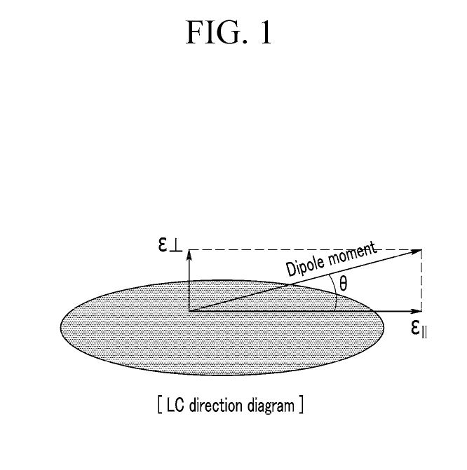

Referring to FIG. 1, as the vertical directional dielectric constant ∈⊥ of the liquid crystal director is increased, an angle of a dipole moment with a long axis (i.e., optical axis) direction of the liquid crystal molecule is increased. When the vertical direction dielectric constant is increased due to the increase in the dipole moment angle, the deformation of the liquid crystal molecular alignment with respect to the same voltage is reduced. Accordingly, the flexoelectric level is lowered and the flicker phenomenon caused thereby can be reduced. The liquid crystal composition according to the exemplary embodiment includes dioxane so that the vertical direction dielectric constant can be increased and the flicker phenomenon can be reduced.

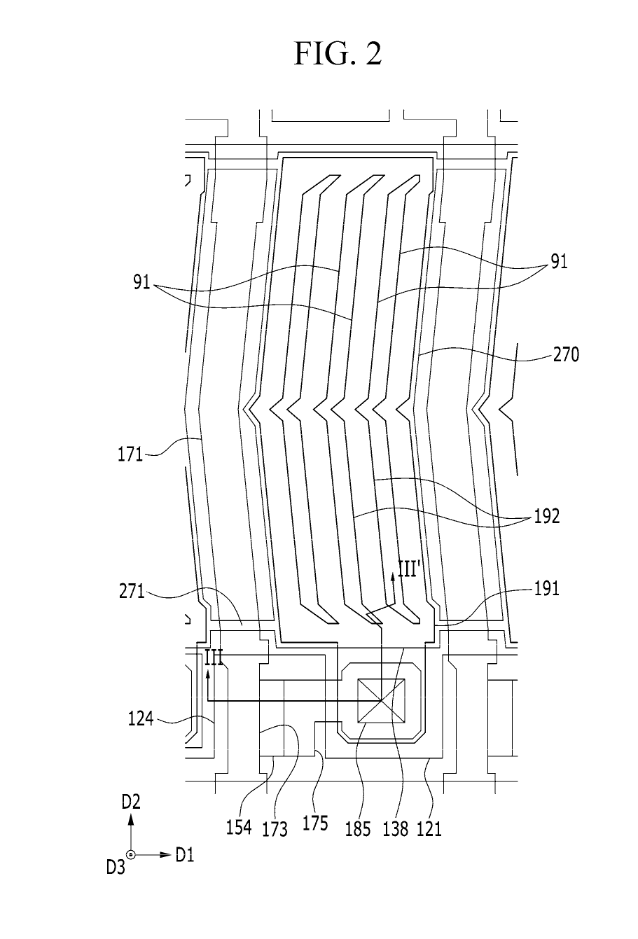

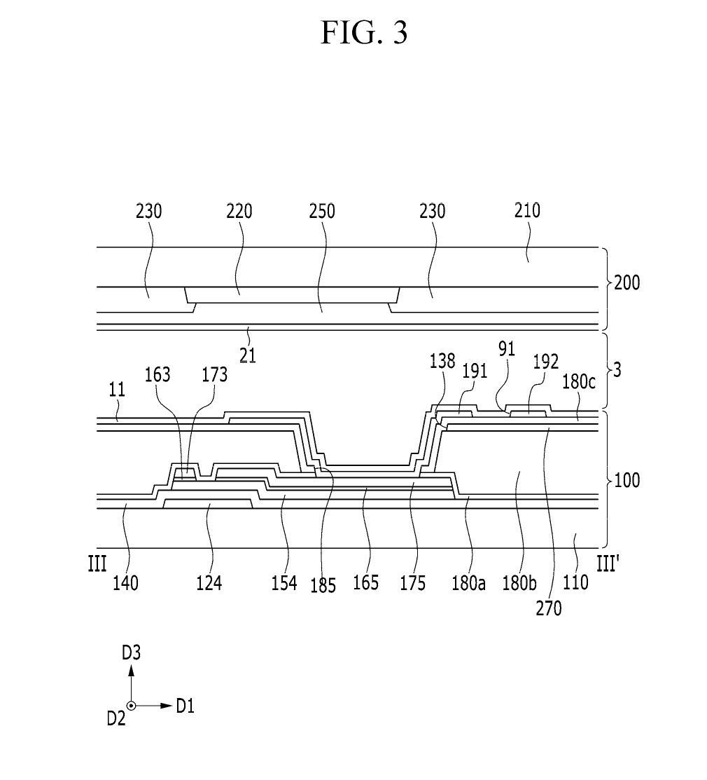

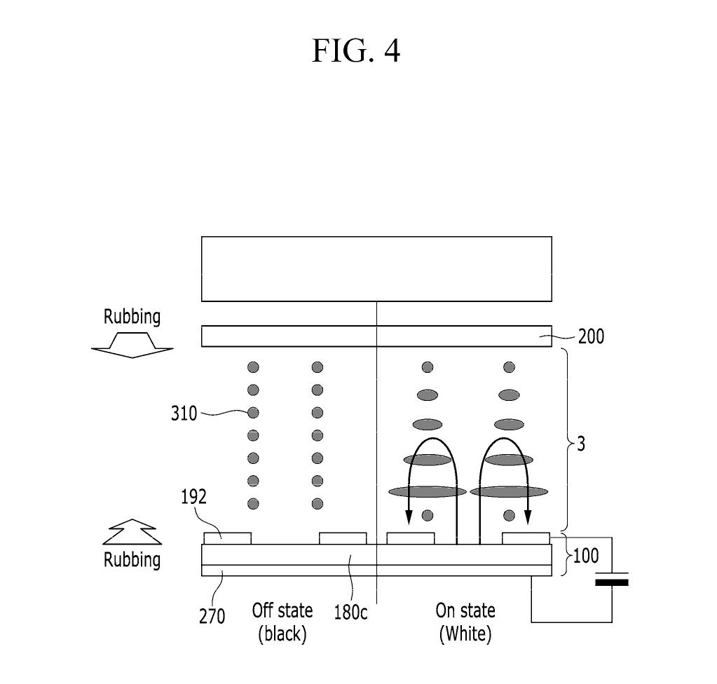

Hereinafter, a liquid crystal display that includes the above-described liquid crystal composition will be described with reference to FIGS. 2, 3, and 4. FIG. 2 is a top plan view of a liquid crystal display according to an exemplary embodiment. FIG. 3 is a cross-sectional view taken along line III-III′ of FIG. 2. FIG. 4 is a schematic cross-sectional view of a liquid crystal molecule alignment according to whether or not an electric field is applied in the liquid crystal display according to the exemplary embodiment.

Referring to FIG. 2 and FIG. 3, the liquid crystal display includes a lower panel 100, an upper panel 200, and a liquid crystal layer 3 that is disposed between the lower panel 100 and the upper panel 200.

The lower panel 100 will now be described.

A gate line 121 that includes a gate electrode 124 is provided on a first substrate 110 that is made of transparent glass or plastic. The gate line 121 may include a wide end portion (not shown) for connection not only with the gate electrode 124 but also with another layer or an external driving circuit.

The gate line 121 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such molybdenum (Mo) or a molybdenum alloy, chromium (Cr), tantalum (Ta), and titanium (Ti). The gate line 121 may have a multilayer structure including at least two conductive layers having different physical properties.

A gate insulating layer 140 that is made of a silicon nitride (SiNx) or a silicon oxide (SiOx) is provided on the gate line 121. The gate insulating layer 140 may have a multilayer structure including at least two insulation layers having different physical properties.

A semiconductor layer 154 that is made of amorphous silicon, polysilicon, or an oxide semiconductor is provided on the gate insulating layer 140.

Ohmic contacts 163 and 165 may be provided on the semiconductor layer 154, and when the semiconductor layer 154 is made of an oxide semiconductor, the ohmic contacts 163 and 165 can be omitted.

Data conductors 171, 173, and 175 that include a data line 171 and a drain electrode 175 are provided on the ohmic conductors 163 and 165. The data line 171 includes a source electrode 173. The data line 171 may include a wide end portion (not shown) for connection with another layer or an external driving circuit.

The data line 171 transmits a data signal, and extends mainly in a vertical direction and crosses the gate line 121.

The data line 171 may have a curved portion that has a bent shape so as to maximize transmittance of the liquid crystal display, and the curved portion may be V-shaped by meeting at a middle area of a pixel area.

The gate electrode 124, the source electrode 173, and the drain electrode 175 form a single thin film transistor together with the semiconductor layer 154, and a channel of the thin film transistor is provided in the semiconductor layer 154 that is disposed between the source electrode 173 and the drain electrode 175.

The data conductors 171, 173, and 175 that include the data line 171 and the drain electrode 175 may be provided as a single layer or a multilayer that is made of a refractory metal such as molybdenum, chromium, tantalum, and titanium, or an alloy thereof.

A first passivation layer 180a is provided on the data conductors 171, 173, and 175, the gate insulating layer 140, and an exposed portion of the semiconductor layer 154. The first passivation layer 180a may be made of an organic insulation material or an inorganic insulation material.

A second passivation layer 180b may be provided on the first passivation layer 180a. The second passivation layer 180b may be made of an organic insulator.

Alternatively, the second passivation layer 180b may be a color filter. When the second passivation layer 180b is provided as a color filter, the second passivation layer 180b may display one unique color among primary colors such as red, green, and blue or yellow, cyan, magenta, and the like. Although it is not illustrated, the color filter may further include a color filter that displays a mixed color of the primary colors or a white color in addition to the primary colors. When the second passivation layer 180b is a color filter, a color filter 230 of the upper panel 200 may be omitted. Unlike the present exemplary embodiment, the second passivation layer 180b may be made of an organic insulation material, and a color filter (not shown) may be provided between the first passivation layer 180a and the second passivation layer 180b.

A common electrode 270, which is a first electrode, is provided on the second passivation layer 180b. The common electrode 270 may be a planar-shaped electrode, and may be provided as a plate on the entire surface of the first substrate 110.

The common electrode 270 includes an opening 138 that is disposed in an area that corresponds to the periphery of the drain electrode 175. The opening 138 may extend in a first direction D1 that is parallel with the gate line 121. In addition, common electrodes 270 that neighbor each other in the direction of the gate line 121, which is, the first direction D1, may be connected with each other through a connection portion 271.

Common electrodes 270 that are disposed in adjacent pixels are connected with each other and thus may receive a common voltage of a constant magnitude supplied from outside the display area.

An insulation layer 180c is provided on the common electrode 270. The insulation layer 180c may be formed of an organic insulating material or an inorganic insulating material.

A pixel electrode 191, which is a second electrode, is provided on the insulation layer 180c. The pixel electrode 191 may have a curved edge that is almost parallel with a curved portion of the data line 171. The pixel electrode 191 includes a plurality of cutouts 91 and a plurality of branch electrodes 192, each disposed between neighboring cutouts 91. In a plan view, the plurality of branch electrodes 192 overlap the common electrode 270.

The first passivation layer 180a, the second passivation layer 180b, and the insulation layer 180c have a contact hole 185 that exposes the drain electrode 175. The pixel electrode 191 is physically and electrically connected with the drain electrode 175 through the contact hole 185, and thus receives a voltage from the drain electrode 175.

A first alignment layer 11 is provided on the pixel electrode 191 and the insulation layer 180c. The first alignment layer 11 may be a horizontal alignment layer, and is rubbed in a constant direction. The first alignment layer 11 may be a photo-alignment layer rather than being limited to a layer that is rubbed for alignment.

In the liquid crystal display of the above-described exemplary embodiment, the common electrode 270 is described as a planar-shaped electrode and the pixel electrode 191 is described as a branch electrode, but this is not restrictive. The pixel electrode 191 may be a planar-shaped electrode and the common electrode 270 may be a branch electrode.

Next, the upper panel 200 will be described.

A light blocking member 220 is provided between a second substrate 210 that is made of transparent glass or plastic and the liquid crystal layer 3. The light blocking member 220 is also called a black matrix, and prevents light leakage.

A plurality of color filters 230 may be provided between the second substrate 210 and the liquid crystal layer 3. When the second passivation layer 180b of the lower panel 100 is a color filter or the lower panel 100 includes an additional color filter, the color filter 230 of the upper panel 200 can be omitted. In addition, the light blocking member 220 of the upper panel 200 may also be disposed in the lower panel 100.

An overcoat 250 is provided between the color filter 230 and the light blocking member 220, and the liquid crystal layer 3. The overcoat 250 may be made of an (organic) insulation material, and prevents exposure of the color filter 230 and provides a flat surface. The overcoat 250 may be omitted depending on exemplary embodiments.

A second alignment layer 21 is provided between the overcoat 250 and the liquid crystal layer 3. The second alignment layer 21 may be made of the same material as the above-described first alignment layer 11.

Referring to FIG. 4, the first alignment layer 11 and the second alignment layer 21 may be rubbed in a direction that is parallel with an extension direction D2 of the plurality of branch electrodes 192. In addition, when the alignment layer is made of a photo-alignment material, the surface of the alignment layer may be photo-aligned in a direction that is parallel with the second direction D2, which is the extension direction of the plurality of branch electrodes 192.

Liquid crystal molecules 310 of the liquid crystal layer 3 may be parallel to the display panels 100 and 20 in the long axis direction of the liquid crystal molecules 310. In particular, the long axis of the liquid crystal molecules 310 according to the exemplary embodiment may extend in parallel with the second direction D2 while no electric field is applied thereto (i.e., in an off state). That is, the liquid crystal molecules 310 are tilted in a direction in which the plurality of branch electrodes 192 extend. The long axis of the liquid crystal molecules 310 according to the exemplary embodiment may be parallel with an electric field direction in an on state, which is a state in which an electric field is applied to the branch electrode 192 and the common electrode 270.

The liquid crystal layer 3 is disposed between the lower panel 100 and the upper panel 200. In the exemplary embodiment, the liquid crystal layer 3 may be made of a liquid crystal composition that includes a compound that includes dioxane. Specifically, the liquid crystal composition may be the above-described liquid crystal composition.

Referring back to FIG. 2 and FIG. 3, the pixel electrode 191 receives a data voltage from the drain electrode 175, and the common electrode 270 receives a common voltage having a constant magnitude from a common voltage application unit (not shown) that is disposed outside the display area.

The pixel electrode 191 and the common electrode 270, which are field generating electrodes, generate an electric field such that the liquid crystal molecules of the liquid crystal layer 3, disposed on the two electric field generation electrodes 191 and 270, may be perpendicular to a direction of the electric field or may rotate in a direction that is parallel to the electric field direction. The polarization of light passing through the liquid crystal layer varies according to the determined rotation direction of the liquid crystal molecules.

A polarizer (not shown) may be disposed in an outer side of each of the display panels 100 and 200. Transmission axes of the respective polarizers may perpendicularly cross each other, and one of the perpendicularly-crossed transmission axes may be parallel with the gate line 121. In case of a reflective liquid crystal display, one of the two polarizers may be omitted.

A driving frequency of the above-stated liquid crystal display may be 60 Hz or less. The driving frequency may be 30 Hz or less. The visibility of the flicker phenomenon may vary depending on the driving frequency of the liquid crystal display device, and the visibility of the flicker phenomenon may be significant when the liquid crystal display is driven with a low frequency level such as 30 Hz. However, when the liquid crystal composition that includes dioxane is included, the visibility of the flicker phenomenon may be reduced even through the liquid crystal display is driven with a low frequency level such as 30 Hz according to the exemplary embodiment.

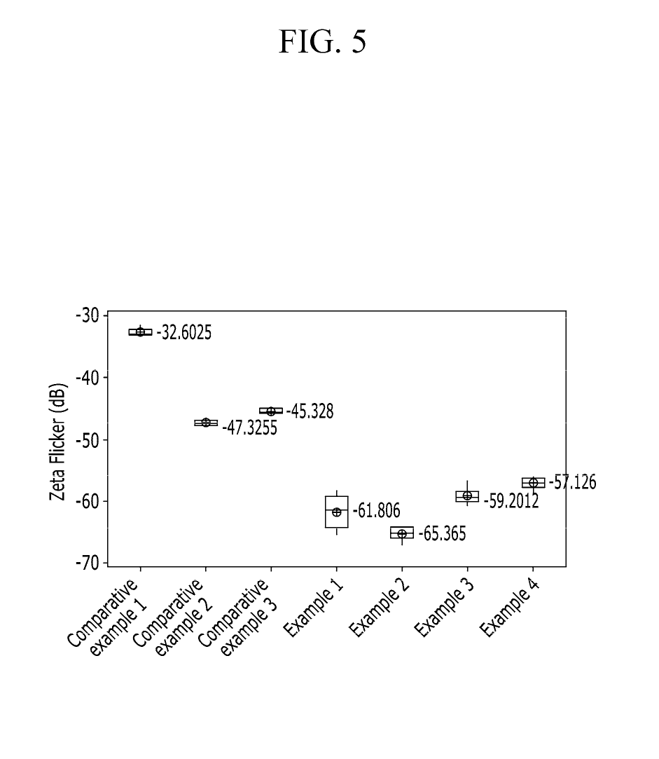

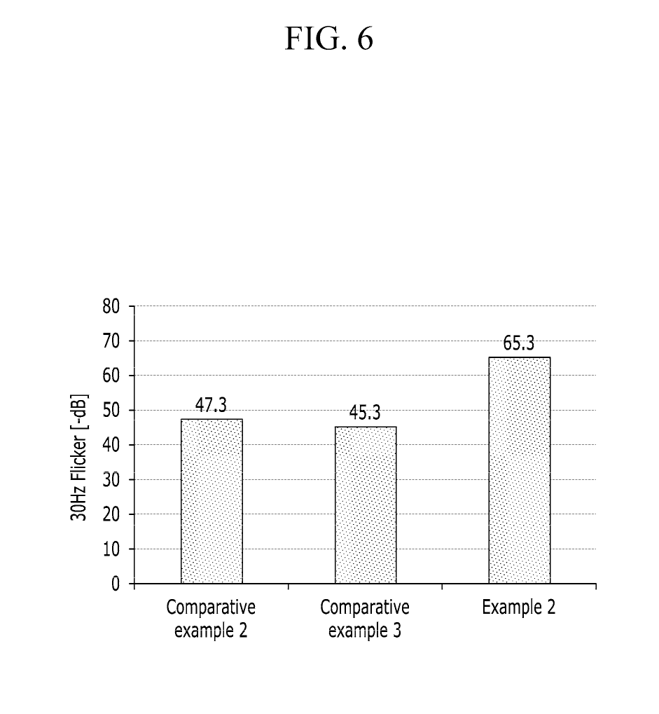

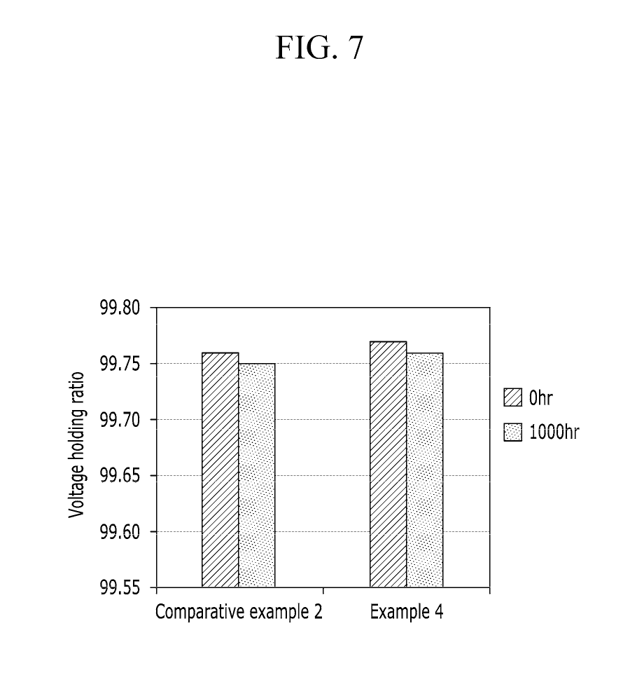

Hereinafter, properties according to an exemplary embodiment and a comparative example will be described with reference to FIG. 5, FIG. 6, and FIG. 7. FIG. 5 is a graph illustrating zeta flicker values according to exemplary embodiments and comparative examples. FIG. 6 is a graph illustrating flicker values at 30 Hz according to the exemplary embodiments and the comparative examples. FIG. 7 is a graph illustrating a voltage holding ratio (VHR) according to the exemplary embodiments and the comparative examples.

Tables 1 to 7 show liquid crystal compositions according to Exemplary Embodiments 1 to 4 and Comparative Examples 1 to 3. Table 1 shows Exemplary Embodiment 1, Table 2 shows Exemplary Embodiment 2, Table 3 shows Exemplary Embodiment 3, Table 4 shows Exemplary Embodiment 4, Table 5 shows Comparative Example 1, Table 6 shows Comparative Example 2, and Table 7 shows Comparative Example 3. In Table 1, X and Y independently denote an alkyl group having 1 to 7 carbon atoms, an alkenyl group having 2 to 7 carbon atoms, or an alkoxy group having 1 to 7 carbon atoms. R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

TABLE 1

| Liquid crystal compound | Amounts (wt %) |
|---|---|
| 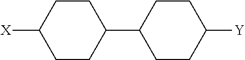 | 38.5 |
| 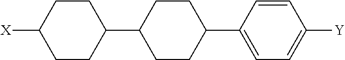 | 15 |
| 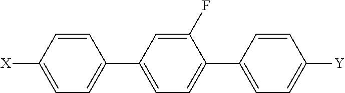 | 9.5 |
| 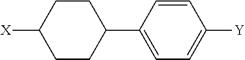 | 8 |
| 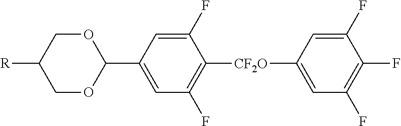 | 5 |
| 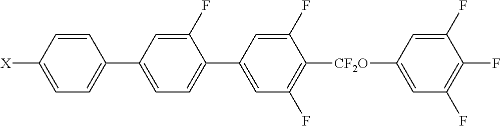 | 8 |
| 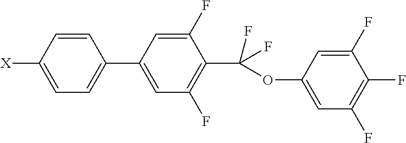 | 1 |
| 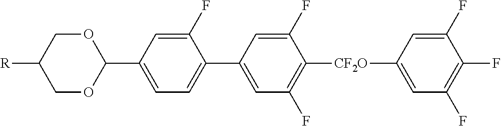 | 5 |
| 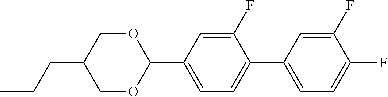 [SMILES: CCCC1COC(c2ccc(-c3ccc(F)c(F)c3)c(F)c2)OC1] | 10 |

TABLE 2

| Liquid crystal compound | Amounts (wt %) |
|---|---|
| 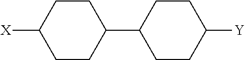 | 39.5 |
| 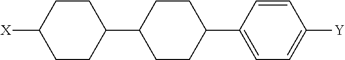 | 13.5 |
| 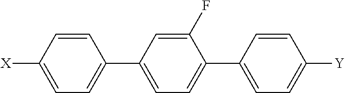 | 13 |
| 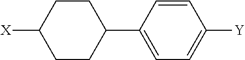 | 8 |
| 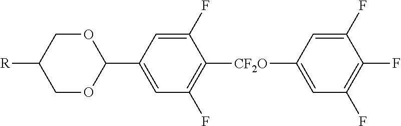 | 5 |
| 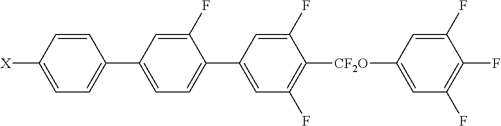 | 5 |
| 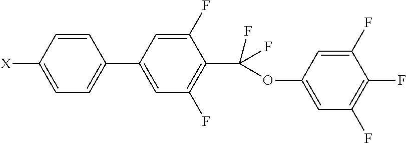 | 1 |
| 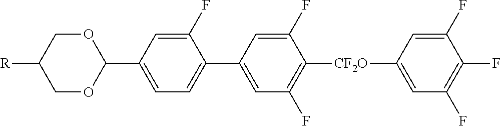 | 5 |
| 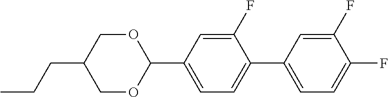 [SMILES: CCCC1COC(c2ccc(-c3ccc(F)c(F)c3)c(F)c2)OC1] | 10 |

TABLE 3

| Liquid crystal compound | Amounts (wt %) |
|---|---|
| 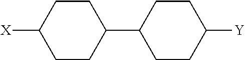 | 46 |
| 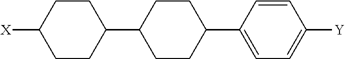 | 20 |
| 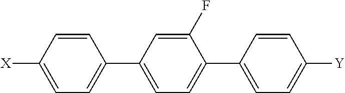 | 5 |
| 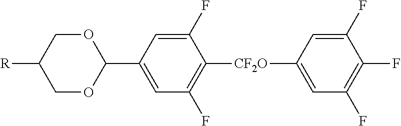 | 5 |
| 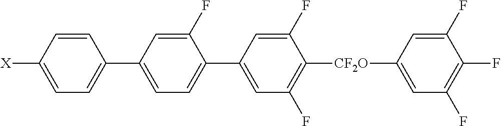 | 8 |
| 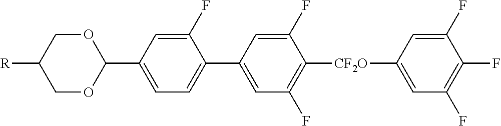 | 5 |
| 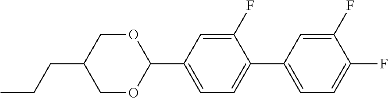 [SMILES: CCCC1COC(c2ccc(-c3ccc(F)c(F)c3)c(F)c2)OC1] | 10 |
| 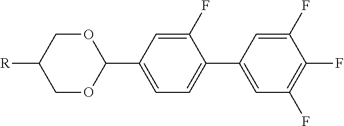 | 1 |

TABLE 4

| Liquid crystal compound | Amounts (wt %) |
|---|---|
| 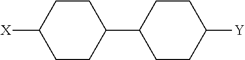 | 41 |
| 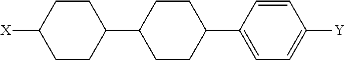 | 24 |
| 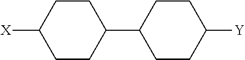 | 2 |
| 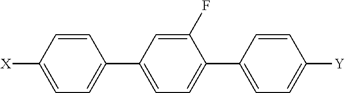 | 5 |
| 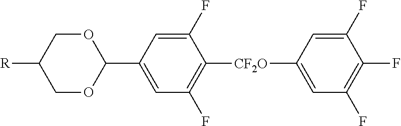 | 5 |
| 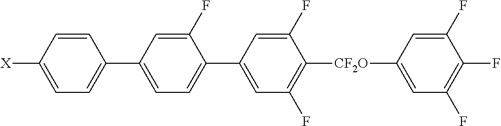 | 8 |
| 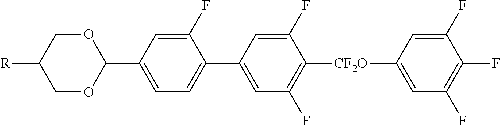 | 5 |
| 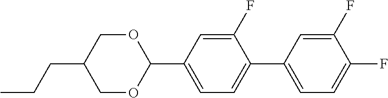 [SMILES: CCCC1COC(c2ccc(-c3ccc(F)c(F)c3)c(F)c2)OC1] | 8 |
| 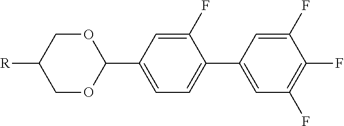 | 2 |

TABLE 5

| Liquid crystal compound | Amounts (wt %) |
|---|---|
| 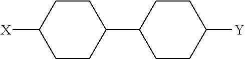 | 21 |
| 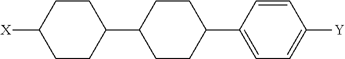 | 10 |
| 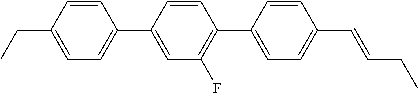 [SMILES: CC/C=C/c1ccc(-c2ccc(-c3ccc(CC)cc3)cc2F)cc1] | 8 |
| 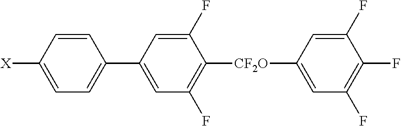 | 15 |
| 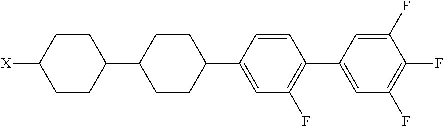 | 3 |
| 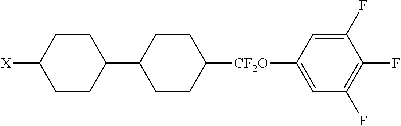 | 18 |
| 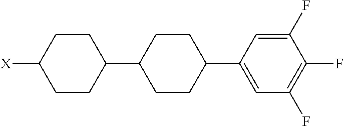 | 10 |
| 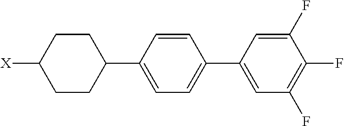 | 15 |

TABLE 6

| Liquid crystal compound | Amounts (wt %) |
|---|---|
| 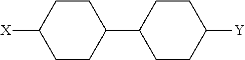 | 50 |
| 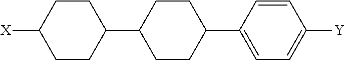 | 10 |
| 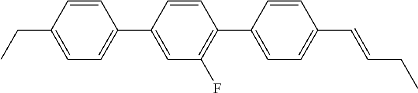 [SMILES: CC/C=C/c1ccc(-c2ccc(-c3ccc(CC)cc3)cc2F)cc1] | 7.5 |
| 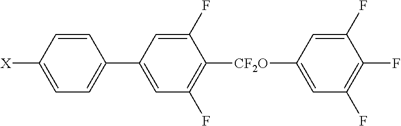 | 5.5 |
| 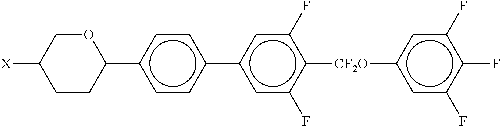 | 15.5 |
| 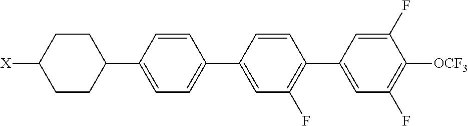 | 11.5 |

TABLE 7

| Liquid crystal compound | Amounts (wt %) |
|---|---|
| 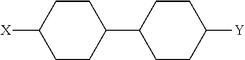 | 34 |
| 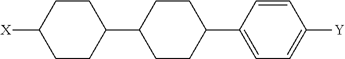 | 6 |
| 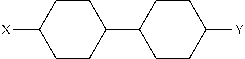 | 20 |
| 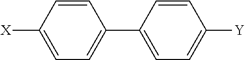 | 5 |
| 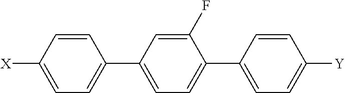 | 6.5 |
| 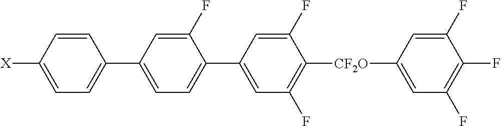 | 15.5 |
| 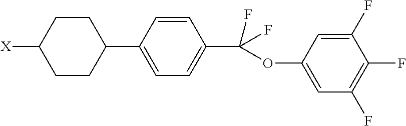 | 10 |
| 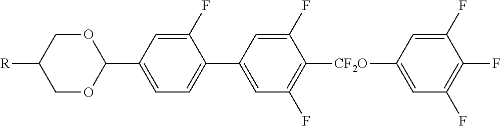 | 3 |

The above-stated Exemplary Embodiments 1 to 4 and Comparative Examples 1 to 3 will be described with reference to FIG. 5 and FIG. 6. The zeta flicker values in FIG. 5 and the flicker values at 30 Hz in FIG. 6 are scales that indicate the degree of the flicker phenomenon, wherein the flicker occurs less as the value is lower, and the zeta flicker values have negative values in FIG. 5. In FIG. 6, the flicker values are scales in −dB, and therefore the value is lower as the absolute value is increased.

First, as shown in FIG. 5, the liquid crystal compositions according to Exemplary Embodiments 1 to 4 include a liquid crystal compound that includes dioxane. Thus, zeta flicker values are lower that in Comparative Examples 1 to 3, and it can be observed that visibility of the flicker phenomenon in a liquid crystal display is reduced.

In addition, in FIG. 6, comparing Comparative Example 3 that includes dioxane in an amount of 3 wt % with respect to the total liquid crystal composition and Exemplary Embodiment 2 that includes dioxane in an amount of 20 wt % with respect to the total liquid crystal composition, Exemplary Embodiment 2 has a value of −65.3 dB and Comparative Example 3 has a value of −45.3 dB. As a result, the flicker phenomenon can be reduced as it contains not only dioxane but also a predetermined amount (about 20 wt %) or more thereof.

Referring to FIG. 7, the liquid crystal display that includes the liquid crystal composition according to Exemplary Embodiment 4 has an excellent voltage holding ratio (VHR) compared to the liquid crystal display that includes the liquid crystal composition according to Comparative Example 2. That is, it was determined that the liquid crystal composition according to the exemplary embodiment not only reduces the flicker phenomenon but also improves the voltage holding ratio.

TABLE 8

| | Exemplary | Exemplary | Exemplary | Exemplary | | | |
|---|---|---|---|---|---|---|---|
| | Embodiment | Embodiment | Embodiment | Embodiment | Comparative | Comparative | Comparative |
| | 1 | 2 | 3 | 4 | Example 1 | Example 2 | Example 3 |
| Δn | 0.110 | 0.110 | 0.102 | 0.101 | 0.1095 | 0.1095 | 0.111 |
| nₑ | 1.597 | 1.599 | 1.587 | 1.587 | 1.5946 | 1.5946 | 1.597 |
| nₒ | 1.487 | 1.489 | 1.485 | 1.486 | 1.4851 | 1.4851 | 1.486 |
| Δϵ | 7.1 | 6.1 | 7.1 | 7.0 | 9.1 | 9.1 | 6.0 |
| ϵ _{\|\|} | 10.7 | 9.8 | 10.6 | 10.5 | 12.4 | 12.4 | 8.8 |
| ϵ _{⊥} | 3.6 | 3.7 | 3.5 | 3.5 | 3.3 | 3.3 | 2.8 |
| Y₁ (mPa · s) | 72.3 | 68.8 | 71.1 | 71.8 | 65.0 | 65.0 | 50.8 |
| K₁₁ | 12.0 | 12.0 | 13.6 | 13.9 | 12.9 | 12.9 | 12.6 |
| K₃₃ | 14.2 | 14.1 | 16.6 | 16.1 | 13.9 | 13.9 | 13.8 |
| Tₙᵢ (° C.) | 80.4 | 80.0 | 89.9 | 91.9 | 80 | 80 | 80.1 |

TABLE 9

| | Exemplary | Exemplary | Comparative | Comparative |
|---|---|---|---|---|
| | Embodiment 3 | Embodiment 4 | Example 2 | Example 3 |
| K | 12.33 | 12.32 | 11.08 | 10.90 |
| S_{lc} | 0.00796 | 0.00782 | 0.01026 | 0.01074 |
| S_{cell} | 0.02707 | 0.02659 | 0.03283 | 0.03438 |
| White | 450 | 443 | 405 | 445 |
| luminance | | | | |
| Black | 0.306 | 0.307 | 0.385 | 0.377 |
| luminance | | | | |
| Contrast | 1471 | 1442 | 1052 | 1180 |
| ratio (CR) | | | | |

Hereinafter, the properties according to the exemplary embodiments and the comparative examples will be described with reference to Table 8 and Table 9.

A vertical direction dielectric constant ∈_{⊥} is higher in Exemplary Embodiments 1 to 4 compared to Comparative Examples 1 to 3. That is, the vertical direction dielectric constant is increased when the liquid crystal composition that includes dioxane is included with an amount of about 20 wt % with respect to the amount of the total liquid crystal composition. When the vertical direction dielectric constant is increased, the flicker phenomenon can be reduced as described above.

Further, referring to Table 9, the value of K is increased according to Exemplary Embodiments 3 and 4, and accordingly, values of S_{lc} and S_{cell} are reduced.

Specifically, the contrast ratio of the liquid crystal display device is derived from white luminance/black luminance, and the black luminance can be lowered or the white luminance can be increased to improve the contrast ratio. As a method of lowering the black luminance, there is a method of lowering a scattering index which is one of the physical properties of the liquid crystal composition, and the scattering index can be expressed by the following Equation 1 or Equation 2.

$$\begin{matrix}{S}_{lc} = \frac{{\{ Δ n ( {n}_{e} + {n}_{o} ) \}}^{2}}{K} & ( Equation 1 ) \\ {S}_{cell} = \frac{{\{ Δ n ( {n}_{e} + {n}_{o} ) \}}^{2}}{K} \cdot d & ( Equation 2 )\end{matrix}$$

Herein, S_{lc} denotes a scattering index of the liquid crystal composition and S_{cell} denotes a scattering index of the liquid crystal layer. In this case, nₑ denotes a long axis refractive index of the liquid crystal molecule, nₒ denotes a short axis refractive index, Δn denotes nₑ-nₒ, K denotes an average value of elastic coefficients K₁₁, K₂₂, and K₃₃, and d denotes a cell gap of the liquid crystal layer.

In Equation 1 and Equation 2, Δn may be lowered or K may be increased to decrease the values of S_{lc} and S_{cell}, and the scattering index of the liquid crystal composition according to the present invention can be lowered by increasing the value of K. As shown in Table 9, in Exemplary Embodiments 3 and 4, it is possible to have a large K value as compared with the comparative examples, and as a result, the black luminance value is reduced and the contrast ratio is improved.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent is arrangements.

What is claimed is:

1. A liquid crystal composition, comprising at least one compound selected from the group consisting of Chemical Formula 1, Chemical Formula 2, Chemical Formula 3, and Chemical Formula 4,
wherein Chemical Formulas 1, 2, 3, and 4 are as follows: 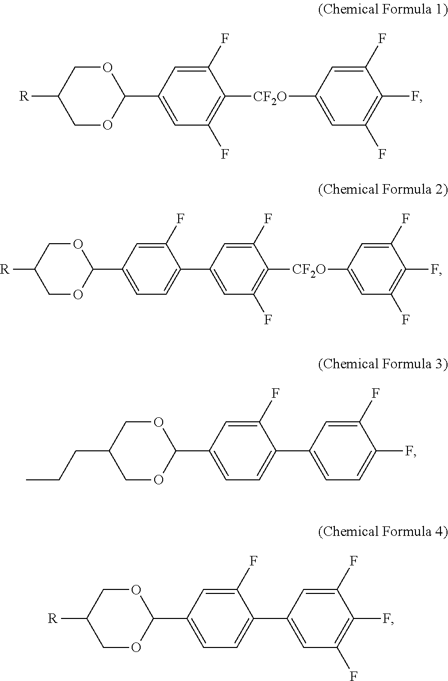
and
wherein R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

2. The liquid crystal composition of claim 1, wherein:
the liquid crystal composition comprises a compound represented by Chemical Formula 1, a compound represented by Chemical Formula 2, and a compound represented by Chemical Formula 3, and
a total amount of compounds represented by Chemical Formulas 1, 2, and 3 is about 20 wt % or more compared to an amount of the entire liquid crystal composition.

3. The liquid crystal composition of claim 2, wherein an amount of each of the respective compounds represented by Chemical Formulas 1, 2, and 3 is about 5 wt % or more compared to the amount of the entire liquid crystal composition.

4. The liquid crystal composition of claim 1, wherein an amount of a compound represented by Chemical Formula 4 is about 1 wt % or more compared to an amount of the entire liquid crystal composition.

5. The liquid crystal composition of claim 1, wherein the liquid crystal composition has positive dielectric anisotropy.

6. A liquid crystal display, comprising:
a first substrate;
a first electrode and a second electrode disposed on the first substrate and insulated from each other;
a second substrate overlapping the first substrate; and
a liquid crystal layer disposed between the first substrate and the second substrate,
wherein the liquid crystal layer comprises a liquid crystal composition comprising at least one compound selected from the group consisting of Chemical Formula 1, Chemical Formula 2, Chemical Formula 3, and Chemical Formula 4,
wherein Chemical Formulas 1, 2, 3, and 4 are as follows: 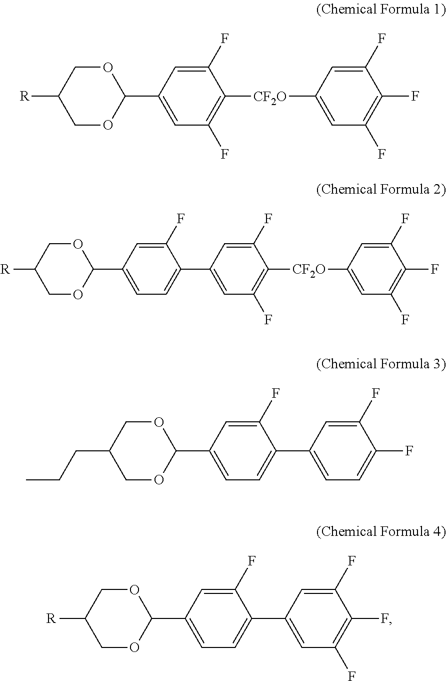
and
wherein R denotes an alkyl group having 1 to 7 carbon atoms, an alkenyl group having 2 to 7 carbon atoms, or an alkoxy group having 1 to 7 carbon atoms, independently, in Chemical Formula 1, Chemical Formula 2, and Chemical Formula 4.

7. The liquid crystal display of claim 6, wherein:
the liquid crystal composition comprises a compound represented by Chemical Formula 1, a compound represented by Chemical Formula 2, and a compound represented by Chemical Formula 3, and
a total amount of compounds represented by Chemical Formulas 1, 2, and 3 is about 20 wt % or more compared to an amount of the entire liquid crystal composition.

8. The liquid crystal display of claim 6, wherein an amount of each of the respective compounds represented by Chemical Formulas 1, 2, and 3 is about 5 wt % or more compared to an amount of the entire liquid crystal composition.

9. The liquid crystal display of claim 6, wherein an amount of the compound represented by Chemical Formula 4 is about 1 wt % or more compared to an amount of the entire liquid crystal composition.

10. The liquid crystal display of claim 6, wherein a driving frequency of the liquid crystal display is 60 Hz or less.

11. The liquid crystal display of claim 6, wherein the liquid crystal composition has positive dielectric anisotropy.

12. The liquid crystal display of claim 6, wherein at least one of the first electrode and the second electrode is a planar-shaped electrode and the other is a branch electrode.

13. The liquid crystal display of claim 12, wherein liquid crystal molecules of the liquid crystal layer are configured to tilt in a direction that is parallel with an extension direction of the branch electrode when no electric field is applied to the liquid crystal layer.

14. The liquid crystal display of claim 12, further comprising an alignment layer that is disposed between the first electrode and the second electrode.

15. The liquid crystal display of claim 14, wherein the alignment layer is rubbed in a direction that is parallel with the branch electrode.

16. The liquid crystal display of claim 14, wherein the alignment layer is photo-aligned in a direction that is parallel with the branch electrode.

17. The liquid crystal display of claim 12, wherein molecules of the liquid crystal layer are configured to tilt in a horizontal direction with respect to an electric field when the electric field is applied to the liquid crystal layer.
